(19) United States
(12) Patent Application Publication
(10) Pub. No.: US 2006/0126585 A1
(43) Pub. Date: Jun. 15, 2006

(54) System to manage wireless connection state between network printer and access point using wireless connection map and a method thereof

(76) Inventor: Byoung-yue Kim, Suwon-si (KR)

Correspondence Address: STANZIONE & KIM, LLP, 919 18TH STREET, N.W., SUITE 440, WASHINGTON, DC, 20006, US

(21) Appl. No.: 11/280,262

(22) Filed: Nov. 17, 2005

(30) Foreign Application Priority Data
Dec. 13, 2004 (KR) 2004-104687

(51) Int. Cl. H04Q 7/24

(52) U.S. Cl. 370/338; 370/401

(57) ABSTRACT

A system and a method to manage a wireless connection state between a network printer and an access point using a wireless connection map. The method includes transmitting wireless connection information inquiry packets to a plurality of network printers to request wireless connection information between the plurality of network printers and access points, checking whether responding packets to the wireless connection information inquiry packets are received for a predetermined time period after the wireless connection information inquiry packets are transmitted, and when the wireless connection information packets are in the predetermined time period, storing the received wireless connection information packets, and when the predetermined time period passes, generating a wireless connection map by assembling the stored wireless connection information packets.

### CROSS-REFERENCE TO RELATED APPLICATIONS

This application claims benefit under 35 U.S.C. § 119(a) of Korean Patent Application No. 2004-104687, filed Dec. 13, 2004, the contents of which are incorporated herein in their entirety by reference.

### BACKGROUND OF THE INVENTION

1. Field of the Invention

The present general inventive concept relates to a system to manage a wireless connection state between a network printer and an access point using a wireless connection map to appropriately cope with trouble with the access point or changes of properties of the access point, and a method of the same.

2. Description of the Related Art

In general, a wireless local area network (WLAN) refers to data communication expanded from a wired LAN or substituting for the wired LAN. In other words, the WLAN is a network system constructed by utilizing atmosphere as a communication channel using high frequency of radio frequency or infrared rays.

FIG. 1 illustrates a structure of a conventional network printing system operated in an infrastructure mode of a WLAN environment. Referring to FIG. 1, in the infrastructure mode, the structure is similar to a conventional wired LAN used in an office, and the WLAN is constructed by connecting an Ethernet hub with an access point (AP) which is a wired or wireless relay. The AP relays packets transceived between a personal computer (PC) and a wireless network printer having a wireless printer server, and for this purpose, wireless values are to be properly set so that the AP and the wireless network printer can form a wireless physical layer. Here, the wireless network printer refers to a printer having a network interface card mounted therein.

The wireless PC and the wireless network printer set to the infrastructure mode form the wireless physical layer with the AP and transmit a printing job according to a general network printing processes, thereby printing out data.

In the conventional network printing system operated in the infrastructure mode, when any change or trouble occurs with wireless properties of the AP connected with the network printer, the wireless physical layer between the network printer and the AP is disconnected and therefore, communication between a mobile host and the network printer is disrupted. In order to resume the wireless communication, appropriate measures are required, such as changing the wireless properties of the network printer forming the wireless physical layer with the AP.

However, in the conventional network printing system, it is hard to recognize whether trouble or changes occur in the wireless properties of the wireless network printers connected to the AP.

### SUMMARY OF THE INVENTION

Accordingly, the present general inventive concept provides a system capable of managing a wireless connection state between a network printer and an access point using a wireless connection map to properly cope with trouble or changes in wireless properties of the access point, and a method of the same.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing a method of managing a wireless connection state between a network printer and an access point using a wireless connection map, the method comprising transmitting wireless connection information inquiry packets to a plurality of network printers to request wireless connection information between the plurality of network printers and access points, checking whether responding packets to the wireless connection information inquiry packets are received for a predetermined time period after the wireless connection information inquiry packets are transmitted, and when the wireless connection information packets are received by the predetermined time, storing the received wireless connection information packets, and when the predetermined time period passes, generating a wireless connection map by assembling the stored wireless connection information packets.

The method may further comprise displaying the generated wireless connection map on a screen.

The wireless connection information inquiry packets may be broadcast to the plurality of network printers.

The responding packets may include information regarding the wireless connection state between the network printers and the access points.

Upon a user's request, the generated wireless connection map may be stored in a predetermined folder together with a predetermined identification (ID).

The predetermined ID may include date, time and day of the week.

The information regarding the wireless connection state may include wireless property information and printer state information of the network printers.

The wireless property information may include at least one of a basic service set identification (BSSID), a printer name, a service set identifier (SSID), an internet protocol (IP) address, a wireless frequency and an operation mode.

The printer state information may include information regarding at least one of operation states of the network printers including an offline state, a standby state, a printing state, and a jam state, information regarding quantity of remaining toner and information on the number of printed pages.

The foregoing and/or other aspects of the present general inventive concept may also be achieved by providing a method of wirelessly communicating with a mobile host in a network printer to manage a wireless network environment between the network printer and an access point, the method comprising receiving inquiry data packets requesting wireless connection information wirelessly transmitted from the mobile host, obtaining the requested wireless connection information with respect to the wireless network environment in response to the received inquiry data packets, and transmitting response data packet corresponding to the received inquiry data packets and including the obtained wireless connection information to the mobile host.

The foregoing and/or other aspects of the present general inventive concept may also be achieved by providing a system to manage a wireless connection state between a network printer and an access point, the system comprising a mobile host including a wireless communication unit to transmit wireless connection information inquiry packets to a plurality of network printers to request wireless connection information between the plurality of network printers and access points, a control unit to check whether responding packets to the wireless connection information inquiry packets are received for a predetermined time period after the wireless communication unit transmits the wireless connection information inquiry packets, a storage unit to store the received wireless connection information packets when the wireless connection information packets are periodically and continuously received in the predetermined time period, and a wireless connection processing unit to generate a wireless connection map by assembling the stored wireless connection information packets.

The system may further comprise a plurality of network printers including a packet reception unit to receive the wireless connection information inquiry packets from the mobile host, a wireless connection information generation unit to obtain wireless connection information of the network printers in a current wireless network environment and to generate responding packets to the wireless connection information inquiry packets, and a packet transmission unit to transmit the responding packets to the mobile host.

The system may further comprise a plurality of access points to relay the wireless connection information inquiry packets and the responding packets between the mobile host and the plurality of network printers.

The mobile host may further comprise a display unit to display the generated wireless connection map thereon.

The wireless connection information inquiry packets may be broadcast to the plurality of network printers.

The responding packets may include information regarding the wireless connection state between the network printers and the access points.

The information regarding the wireless connection state may include wireless property information and printer state information of the network printers.

The wireless property information may include a basic service set identification (BSSID), a printer name, an SSID, an internet protocol (IP) address, a wireless frequency and an operation mode.

The printer state information may include information regarding operation states of the network printers including an offline state, a standby state, a printing state, and a jam state, information regarding quantity of remaining toner, and information regarding number of printed pages.

The foregoing and/or other aspects of the present general inventive concept may also be achieved by providing a network printing device to wirelessly communicate with a host device through a wireless access point in a wireless network environment, the network printing device including a packet reception unit to receive inquiry data packets requesting wireless connection information wirelessly transmitted from the host device, a wireless connection generation unit to obtain the requested wireless connection information with respect to the wireless network environment, and a packet transmission unit to wirelessly transmit response data packets including the obtained wireless connection information to the host device.

The foregoing and/or other aspects of the present general inventive concept may also be achieved by providing a wireless network system, including a mobile host to broadcast to broadcast inquiry data packets to request predetermined wireless connection information, to receive response data packets including the requested wireless connection information, and to generate a wireless connection map according to received wireless connection information, one or more network printers to receive the broadcast inquiry data packets, to obtain the requested wireless connection information, and to transmit the response data packets including the obtained wireless connection information to the mobile host, and one or more wireless access points to relay the inquiry data packets and the response data packets between the mobile host and the one or more network printers.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. is a diagram illustrating a conventional network printing system operated in an infrastructure mode in a wireless local area network (LAN) environment;

FIG. 2 is a block diagram illustrating a system to manage a wireless connection state between a network printer and an access point using a wireless connection map, according to an embodiment of the present general inventive concept;

FIG. 3 is a flowchart illustrating a method of managing a wireless connection state between a network printer and an access point using a wireless connection map, according to an embodiment of the present general inventive concept;

FIG. 4 is a view illustrating an exemplary wireless connection map; and

FIG. 5 is a view illustrating an exemplary wireless connection map history folder.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

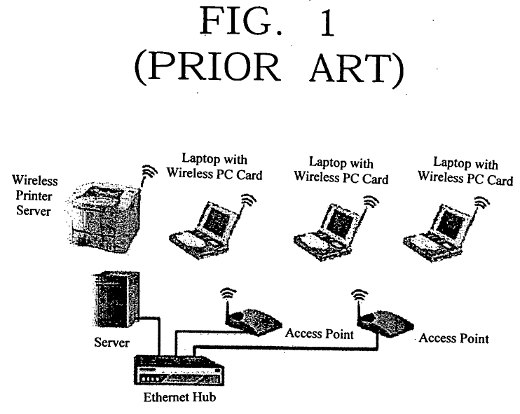

FIG. 2 illustrates a system to manage a wireless connection state between a network printer and an access point using a wireless connection map. Referring to FIG. 2, the system includes a mobile host 100, a plurality of network printers 200a to 200n, and a plurality of access points AP(1) to AP(n).

The mobile host 100 includes a key input unit 110, a control unit 120, a wireless connection processing unit 130, a storage unit 140, a display unit 150, and a wireless communication unit 160. The key input unit 110 generates and outputs key data according to a user's input through keys, or the like. The control unit 120 regulates the overall component parts of the mobile host 100.

The wireless connection processing unit 130 stores a wireless connection map program, which is an application program. When the wireless connection map program stored in the wireless connection processing unit 130 is executed by the control unit 120, the wireless connection processing unit 130 generates wireless connection information inquiry packets to obtain information regarding wireless connection states between the plurality of network printers 200a to 200n and the access points AP(1) to AP(n), and broadcasts the wireless connection information inquiry packets to the network printers 200a to 200n through the wireless communication unit 160.

The control unit 120 periodically or continuously checks whether wireless connection information packets, which are responding packets to the wireless connection information inquiry packets, are received from the network printers 200a to 200n for a predetermined time period after the wireless connection information inquiry packets are broadcast. When the wireless connection information packets are received in the predetermined time period, the control unit 120 stores the received wireless connection information packets in the storage unit 140. When all of the wireless connection information packets are received or when the predetermined time has passed, the wireless connection processing unit 130 assembles the wireless connection information packets stored in the storage unit 140 under the control of the control unit 120, thereby generating a wireless connection map.

Here, the wireless connection information inquiry packets and the wireless connection information packets are transmitted from the mobile host 100 to the network printers 200a to 200n and from the network printer 200a to 200n to the mobile host 100, respectively, by being relayed through the access points AP(1) to AP(n).

The storage unit 140 stores the wireless connection information packets which are the responding packets received from the respective network printers 200a to 200n. The display unit 150 displays the wireless connection map generated by the wireless connection processing unit 130 on a screen thereof.

The wireless communication unit 160 communicates between the mobile host 100 and the network printers 200a to 200n. That is, the wireless communication unit 160 sends the wireless connection information inquiry packets generated by the wireless connection processing unit 130 to the network printers 200a to 200n and receives the wireless connection information packets, as the responding packets to the wireless connection information inquiry packets, from the network printers 200a to 200n. The wireless communication unit 160 can send the wireless connection information inquiry packets to the network printers 200a to 200n and can receive the wireless connection information packets from the network printers 200a to 200n through the access points AP(1) to AP(n).

Each of the plurality of network printers 200a to 200n comprises a packet reception unit 210, a wireless connection information generation unit 220, and a packet transmission unit 230. The packet reception unit 210 receives the wireless connection information inquiry packets from the mobile host 100 through the relay of the access points AP(1) to AP(n) and transmits the received wireless connected information inquiry packets to the wireless connection information generation unit 220. The wireless connection information generation unit 220 obtains the wireless connection information of the respective network printer 200a in a current wireless network environment and thereby generates the wireless connection information packets as the responding packets to the wireless connection information inquiry packets. The packet transmission unit 230 sends the responding packets generated by the wireless connection information generation unit 220 to the mobile host 100 which has broadcast the wireless connection information inquiry packets. The packet transmission unit 230 can send the responding packets to the mobile host 100 through the access points AP(1) to AP(n).

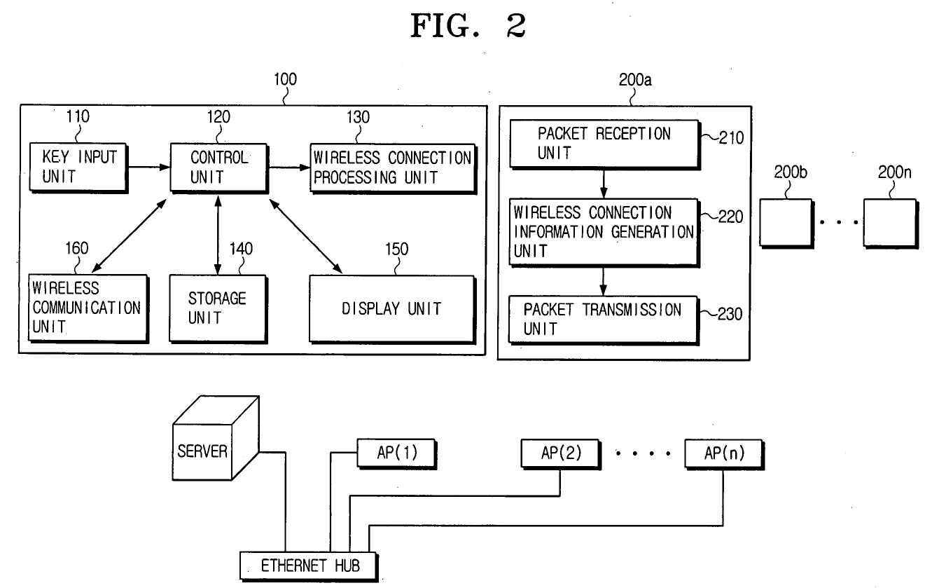

FIG. 3 is a flowchart illustrating a method of managing a wireless connection state between a network printer and an access point using a wireless connection map, according to an embodiment of the present general inventive concept. Referring to FIGS. 2 and 3, when the wireless connection map program, which is the application program stored in the wireless connection processing unit 130, is executed by the control unit 120, the wireless connection processing unit 130 generates the wireless connection information inquiry packets to request information regarding the wireless connection state between the plurality of network printers 200a to 200n and the access points AP(1) to AP(n) wirelessly interconnected on the current wireless network (S310). The generated wireless connection information inquiry packets are broadcast to the plurality of network printers 200a to 200n through the wireless communication unit 160 (S320). Then, the wireless connection processing unit 130 stands by until the responding packets to the wireless connection information inquiry packets are received from the plurality of network printers 200a to 200n.

The packet reception unit 210 of each network printer 200 receives the wireless connection information inquiry packets broadcast from the mobile host 100 (S330) and transmits the received wireless connection information inquiry packets to the wireless connection information generation unit 220. The wireless connection information generation unit 220 obtains the wireless connection information of the respective network printer 200a to 220n in the current wireless network environment and thereby generates the responding packets to the wireless connection information inquiry packets (S340).

Here, the wireless connection information can include a basic service set identification (BSSID), a printer name, an SSID (service set identifier), an internet protocol (IP) address, a wireless frequency, an operation mode and printer state information. The SSID refers to an intrinsic ID of 32 bites attached to a header of each packet transmitted through a wireless LAN. When the wireless network printers 200a to 200n are connected to the BSS, the SSID functions as a password. Network printers having the same SSID form one network. In a network having the same SSID, only the BSSID is used for the wireless communication. The operation mode is related to a mode of the wireless LAN environment, among an infrastructure mode and an ad-hoc mode. The wireless frequency can correspond to various wireless standards, such as an 802.11a standard, an 802.11b standard, and an 802.11g standard. That is, the 802.11b and 802.11g standards operate at the frequency of approximately 2.4 GHz, and the 802.11a standard operates at the frequency of approximately 5.1 GHz.

The printer state information can include an offline state, a standby state, a printing state, and a jam state. Also, information regarding a quantity of remaining toner and a number of printed pages can be included in the printer state information.

The responding packets generated in the wireless connection information generation unit 220 are transmitted to the packet transmission unit 230. The packet transmission unit 230 transmits the responding packets to the mobile host 100 (S350).

When the responding packets are transmitted from the plurality of network printers 200a to 200n, the control unit 120 of the mobile host 100 periodically or continuously checks whether the responding packets are received from the respective network printers 200a to 200n for the predetermined time period after the wireless connection information inquiry packets are broadcast to the network printers 200a to 200n (S360). When the responding packets are received in the predetermined time period (S370), the control unit 120 stores the received responding packets including the wireless connection information of the respective network printers 200a to 200n in the storage unit (S380).

When the predetermined time period passes (S370), the control unit 120 considers the responding packets to be all received from the respective network printers 200a to 200n (S390). The control unit 120 then controls the wireless connection processing unit 130 to assemble the responding packets stored in the storage unit 140 to thereby generate the wireless connection map (S400). The generated wireless connection map is then displayed by the display unit 150 (S410).

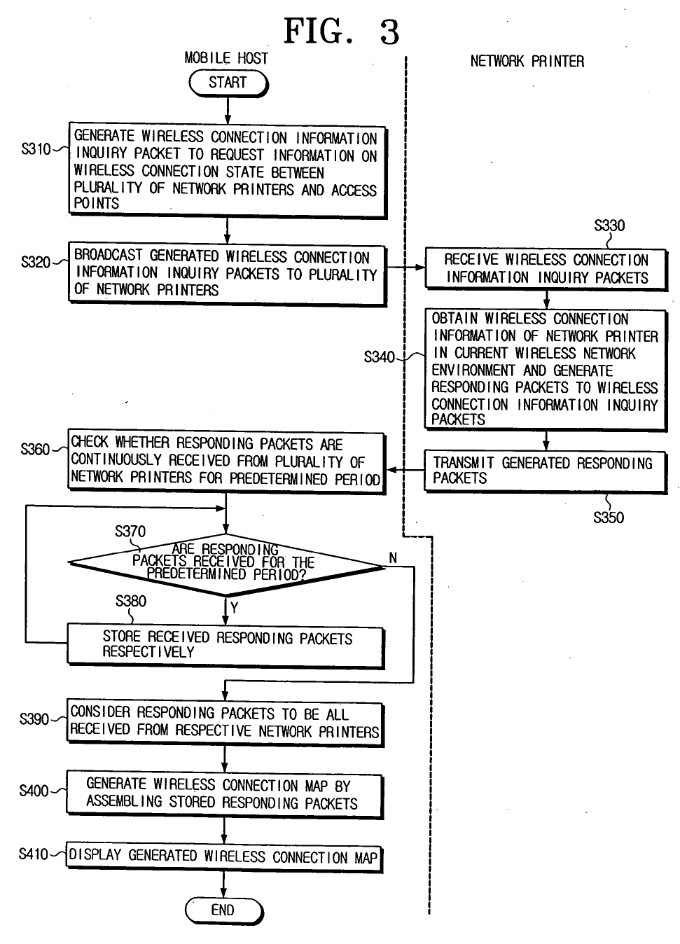

FIG. 4 illustrates an example of the wireless connection map displayed by the display unit 150, as described above. Referring to FIG. 4, the wireless connection map can include the BSSID, the printer name, the SSID, the IP address, the wireless frequency, and the operation mode of the network printers. For convenience, the network printers can be classified according to the BSSID, as illustrated in FIG. 4.

When the user requests storing of the wireless connection map being displayed by the display unit 150, the control unit 120 stores the wireless connection map in the mobile host 100 together with a wireless connection map ID, such as a date, and adds the stored wireless connection map to a wireless connection map history folder. The control unit 120 can automatically store the wireless connection map in the mobile host 100 when the wireless connection map is generated.

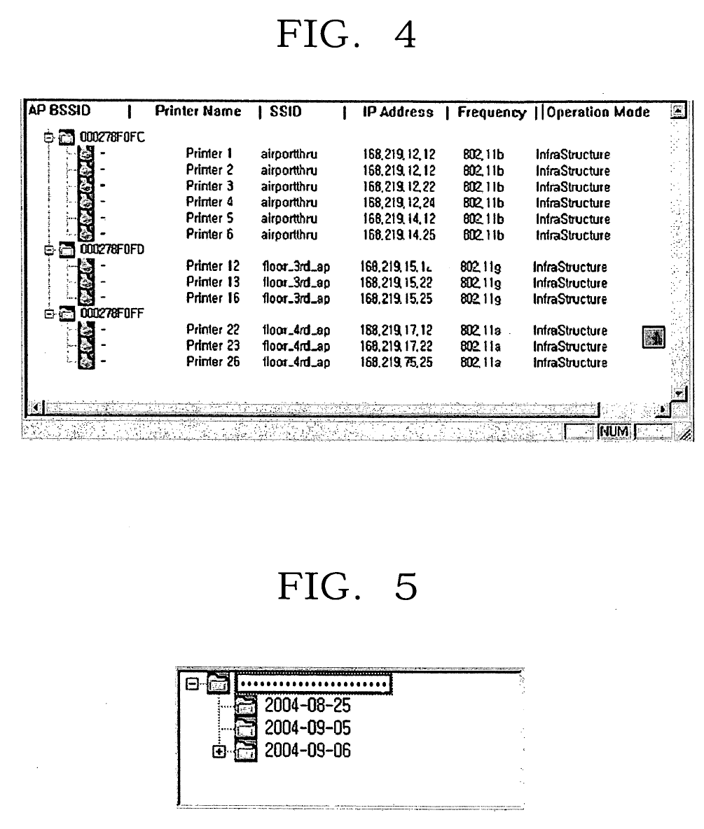

FIG. 5 illustrates an exemplary wireless connection map history folder. Referring to FIG. 5, the wireless connection maps are stored according to the respective wireless connection map IDs in the wireless connection map history folder. As illustrated in FIG. 5, the wireless connection map IDs can be dates.

When wireless properties of access points AP(1) to AP(n) change, since a wireless physical layer of network printers 200a to 200n connected to the access points AP(1) to AP(n) before the change is disconnected, a list of the network printers 200a to 200n connected to the access points AP(1) to AP(n) before the change of the wireless properties is not obtainable. Therefore, the user can use the wireless connection maps stored according to dates before the change of wireless properties from the wireless connection map history folder in order to obtain the list of the network printers 200a to 200n, and appropriately cope with the network printers 200a to 200n.

The present general inventive concept may be embodied as executable code in computer readable media including storage media such as magnetic storage media (ROMs, RAMs, floppy disks, magnetic tapes, etc.), optically readable media (CD-ROMs, DVDs, etc.), and carrier waves (transmission over the Internet).

As described above, according to an embodiment of the present general inventive concept, when wireless properties of an access point are changed, a user can easily cope with the change using a wireless connection map having information regarding a wireless connection between a network printer and the access point.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of managing a wireless connection state between a network printer and an access point using a wireless connection map, the method comprising:
transmitting wireless connection information inquiry packets to a plurality of network printers to request wireless connection information between the plurality of network printers and access points;
checking whether responding packets to the wireless connection information inquiry packets are received for a predetermined time period after the connection information inquiry packets are transmitted; and
when the wireless connection information packets are received in the predetermined time period, storing the received wireless connection information packets, and when the time period passes, generating a wireless connection map by assembling the stored wireless connection information packets.

2. The method of claim 1, further comprising:
displaying the generated wireless connection map on a screen.

3. The method of claim 1, wherein the transmitting of the wireless connection information inquiry packets to the plurality of network printers comprises:
broadcasting the plurality of connection information inquiry packets to the plurality of network printers.

4. The method of claim 1, wherein the responding packets include the requested wireless connection information regarding the wireless connection state between the network printers and the access points.

5. The method of claim 4, wherein the information regarding the wireless connection state includes wireless property information and printer state information of the plurality of network printers.

6. The method of claim 5, wherein the wireless property information comprises a basic service set identification (BSSID), a printer name, a service set identifier (SSID), an internet protocol (IP) address, a wireless frequency, and an operation mode.

7. The method of claim 5, wherein the printer state information comprises information regarding operation states of each network printer including an offline state, a standby state, a printing state, and a jam state, information regarding a quantity of remaining toner, and information regarding a number of printed pages.

8. The method of claim 1, further comprising:
storing the generated wireless connection map in a predetermined folder together with a predetermined identification (ID).

9. The method of claim 8, wherein the predetermined ID comprises a date, a time, and day of the week.

10. The method of claim 1, wherein the checking of whether the responding packets to the wireless connection information inquiry packets are received comprises:
periodically checking whether the responding packets are received during the predetermined time period.

11. The method of claim 1, wherein the checking of whether the responding packets to the wireless connection information inquiry packets are received comprises:
continuously checking whether the responding packets are received during the predetermined time period.

12. The method of claim 1, wherein the wireless connection information inquiry packets are transmitted through one or more access points.

13. The method of claim 1, wherein the response data packets are received through one or more access points.

14. A method of wirelessly communicating with a mobile host in a network printer to manage a wireless network environment between the network printer and an access point, the method comprising:
receiving inquiry data packets requesting wireless connection information wirelessly transmitted from the mobile host;
obtaining the requested wireless connection information with respect to the wireless network environment in response to the received inquiry data packets; and
transmitting response data packet corresponding to the received inquiry data packets and including the obtained wireless connection information to the mobile host within a predetermined time period.

15. A system to manage a wireless connection state between a network printer and an access point, the system comprising a mobile host including:
a wireless communication unit to transmit wireless connection information inquiry packets to a plurality of network printers to request wireless connection information between the plurality of network printers and access points;
a control unit to check whether responding packets to the wireless connection information inquiry packets are received for a predetermined time period after the wireless communication unit transmits the wireless connection information inquiry packets;
a storage unit to store the received wireless connection information packets when the wireless connection information packets are received in the predetermined time period; and
a wireless connection processing unit to generate a wireless connection map by assembling the stored wireless connection information packets.

16. The system of claim 15, further comprising a plurality of network printers, each including:
a packet reception unit to receive the wireless connection information inquiry packets from the mobile host;
a wireless connection information generation unit to obtain wireless connection information of the network printers in a current wireless network environment and to generate responding packets to the wireless connection information inquiry packets; and
a packet transmission unit to transmit the responding packets to the mobile host.

17. The system of claim 16, further comprising:
a plurality of access points to relay the wireless connection information inquiry packets and the responding packets between the mobile host and the plurality of network printers.

18. The system of claim 15, wherein the mobile host further comprises a display unit to display the generated wireless connection map thereon.

19. The system of claim 15, wherein the wireless communication unit broadcasts the wireless connection information inquiry packets to the plurality of network printers.

20. The system of claim 15, wherein the responding packets include information regarding the wireless connection state between the wireless network printers and the access points.

21. The system of claim 20, wherein the information regarding the wireless connection state includes wireless property information and printer state information of the plurality of network printers.

22. The system of claim 21, wherein the wireless property information comprises a basic service set identification (BSSID), a printer name, an SSID, an internet protocol (IP) address, a wireless frequency, and an operation mode.

23. The system of claim 21, wherein the printer state information comprises information regarding operation states of each network printer including an offline state, a standby state, a printing state, and a jam state, information regarding a quantity of remaining toner, and information regarding a number of printed pages.

24. A network printing device to wirelessly communicate with a host device through a wireless access point in a wireless network environment, the network printing device comprising:
a packet reception unit to receive inquiry data packets requesting wireless connection information wirelessly transmitted from the host device;
a wireless connection generation unit to obtain the requested wireless connection information with respect to the wireless network environment in response to the received inquiry data packets; and
a packet transmission unit to wirelessly transmit response data packets corresponding to the received inquiry data packets including the obtained wireless connection information to the host device.

25. A wireless network system, comprising:
a mobile host to broadcast to broadcast inquiry data packets to request predetermined wireless connection information, to receive response data packets including the requested wireless connection information, and to generate a wireless connection map according to received wireless connection information;
one or more network printers to receive the broadcast inquiry data packets, to obtain the requested wireless connection information, and to transmit the response data packets including the obtained wireless connection information to the mobile host; and
one or more wireless access points to relay the inquiry data packets and the response data packets between the mobile host and the one or more network printers.

26. A computer readable recording medium including a method of managing a wireless connection state between a network printer and an access point using a wireless connection map, the method comprising:
transmitting wireless connection information inquiry packets to a plurality of network printers to request wireless connection information between the plurality of network printers and access points;
checking whether responding packets to the wireless connection information inquiry packets are received for a predetermined time period after the connection information inquiry packets are transmitted; and
when the wireless connection information packets are received in the predetermined time period, storing the received wireless connection information packets, and when the time period passes, generating a wireless connection map by assembling the stored wireless connection information packets.

27. A computer readable recording medium including a method of wirelessly communicating with a mobile host in a network printer to manage a wireless network environment between the network printer and an access point, the method comprising:
receiving inquiry data packets requesting wireless connection information wirelessly transmitted from the mobile host;
obtaining the requested wireless connection information with respect to the wireless network environment in response to the received inquiry data packets; and
transmitting response data packet corresponding to the received inquiry data packets and including the obtained wireless connection information to the host device.
